(19) United States
(12) Patent Application Publication
(10) Pub. No.: US 2019/0070881 A1
(43) Pub. Date: Mar. 7, 2019

(54) PRINTING MACHINE FOR DIRECT PRINTING ON CONTAINERS

(71) Applicant: KRONES AG, Neutraubling (DE)

(72) Inventors: Martin WAGNER, Regensburg (DE); Bernhard WESS, Neutraubling (DE); August PEUTL, Woerth/Donau (DE); Kai-Uwe DREGER, Neutraubling (DE); Christian HAJEK, Ergolding (DE)

(21) Appl. No.: 16/053,490

(22) Filed: Aug. 2, 2018

(30) Foreign Application Priority Data
Sep. 4, 2017 (DE) 10 2017 215 446.2

(51) Int. Cl. B41M 5/00; B41F 17/00

(52) U.S. Cl. CPC B41M 5/0082; B41F 17/006

(57) ABSTRACT

The present disclosure describes a printing machine for direct printing on containers, comprising: a continuously rotatable carousel for conveying the containers, a plurality of printing units, and stationary docking stations for docking the printing units to the periphery of the carousel. Due to the fact that the printing machine comprises rail guides stationarily associated with the docking stations and used for separately moving the printing units from a docked-on operating position outwards to a maintenance position spaced apart from the carousel, and back again, the printing units can easily be made accessible from several sides for maintenance and they can be locked quickly and reproducibly at their operating position.

### CROSS REFERENCE TO RELATED APPLICATIONS

This application claims priority to German Application No. 10 2017 215 446.2 entitled “PRINTING MACHINE FOR DIRECT PRINTING ON CONTAINERS,” filed on Sep. 4, 2017, the entire contents of which is hereby incorporated by reference in its entirety for all purposes.

### TECHNICAL FIELD

The present disclosure relates to a printing machine for direct printing on containers.

### BACKGROUND AND SUMMARY

A printing machine of the type in question is known from DE 10 2013 214 980 A1. This printing machine comprises a carousel for conveying containers and stationary printing units with a plurality of print heads, whose distance from the carousel, vertical position and inclination with respect to the containers to be printed on can be adjusted by means of individually controllable radial modules, height modules and tilting modules. The printing units can be docked on individually at the periphery of the carousel with the aid of centering means.

Although this allows a flexible orientation of the print heads and although the printing units can temporarily be detached from the carousel as well as permanently replaced, a comprehensive checking of the function of the printing units and/or maintenance of the printing units is normally only possible with the printing unit docked on the carousel that is ready to operate, i.e. with a fully functional printing machine. Under these conditions, access to individual components for installation and/or maintenance is, however, severely impaired. Also, the individual print heads are difficult to reach during cleaning, so that individual cleaning steps cannot be visually monitored. In addition, there is an increasing need for flexible and fast docking on of the printing units or of other treatment units in different pitch circle sections.

Hence, it would be desirable to reduce or even eliminate at least one of the problems mentioned above, without restricting the positioning accuracy of individual print heads with respect to the carousel.

The posed task is solved by a printing machine. Accordingly, this printing machine serves for direct printing on containers and comprises: a continuously rotatable carousel for conveying the containers; a plurality of printing units; and stationary docking stations for docking the printing units to the periphery of the carousel. According to the present disclosure, the printing machine comprises rail guides stationarily associated with the docking stations and used for separately moving the printing units from a docked-on operating position outwards up to and into a maintenance position and back again.

At the maintenance position, the printing unit is in at least one example arranged at a distance from the carousel and/or the docking station. The distance facilitates the exchange of individual modules, functional units, assemblies and/or components, as well as the exchange of complete printing units.

At the maintenance position, the print heads, in particular together with cleaning stations provided on the printing units, can be checked manually and visually. Flexible supply lines, e.g. from the central machine area on the carousel to the printing units, may remain connected for maintenance work. As a result, the printing units can be checked for proper functioning also at their maintenance position, essentially independently of the operating condition of the carousel.

The rail guides allow precise and collision-free guidance of the printing units between the operating position and the maintenance position.

A stationary association of the rail guides means that the mounting position of the rail guides is fixed with respect to the carousel, e.g. by a screw-type connection, by a form fit of the rail guides with respect to a basic frame of the carousel or the like.

At the maintenance position, a distance between docking frames of the printing units and associated docking stations, e.g. between corresponding end plates of the docking frames and of the docking stations, is in some examples, at least 0.3 m, and in some examples at least 0.6 m.

In at least one example, the rail guides are heavy-duty full extension units, in particular full extension units having an extension length of at least 750 mm. This allows a particularly stable guidance of the printing units on the carousel, independently of external influences.

In one or more examples, the printing machine comprises at least one mounting plate/base plate extending radially beyond the carousel and connected to a stationary basic frame of the printing machine, the rail guides being fixed to/formed in said mounting plate/base plate. The mounting plate/base plate facilitates a precise and reproducible positioning of the individual rail guides with respect to the carousel, and thus also an exact and reproducible positioning of individual printing units on the carousel.

In at least one example, the printing machine comprises a plurality of identical pitch circle sections, each having arranged therein a docking station with two receiving areas of the same kind, each for a respective printing unit, and two rail guides that are parallel to one another. This allows a particularly space-saving arrangement of two respective printing units next to each other while at the same time providing easy access to the individual functional units, assemblies and/or components at the maintenance position of the individual printing units.

In at least one example, the two receiving areas of a docking station are arranged in alignment and/or they have substantially identical structural designs.

In one or more examples, the respective receiving areas and the rail guides are arranged on both sides and in particular in an axially symmetrical manner with respect to a common radial displacement axis for the printing units associated therewith. The printing units can thus be oriented more easily with respect to the respective pitch circle section, in particular in a radial orientation relative to the carousel.

In at least one example, the printing units comprise conically tapering centering bolts for precentering and chucks for locking the printing units at the carousel, and the docking stations comprise centering holes and clamping bolts complementary to said centering bolts and chucks.

The centering bolts allow a self-guiding precentering of the printing units during the approach of the printing units on the rail guides. After precentering, the chucks allow a particularly precise and reproducible fixing of the printing units at their respective target position on the carousel. In addition, the combined effect of precentering and of the rail guides prevents damage to the chucks when the printing units approach the carousel.

In at least one embodiment, the printing units comprise basic frames with uniform mounting points for the rail guides. As a result, individual printing units can flexibly be exchanged for one another or replaced by other types of printing units and/or other treatment units. Positioning on the mounting points allows economical mounting by means of standardized aids and work processes.

In one or more examples, the printing machine additionally comprises height-adjustable and/or elastically flexible support elements for connecting the printing units to the rail guides. Height differences between the rail guide and the docking stations can thus be compensated for on the one hand. On the other hand, a positionally accurate locking at the docking stations is made possible, since any remaining height differences and/or inclinations of the centering bolts and centering holes and/or chucks and clamping bolts are compensated for by the elastic support elements. As a result, the chucks and clamping bolts function as a particularly precise self-centering locking unit.

In at least one example, the printing units each comprise at least one adjustment unit for adjusting print heads, in particular separately, with respect to their vertical and radial positions as well as their tilt towards the carousel. This allows, especially in combination with an elastically flexible support on the rail guides and the self-centering locking at the docking stations, a flexible as well as exact and re-producible positioning of individual print heads with respect to the containers.

In at least one embodiment, the printing units comprise cleaning units with cleaning heads parked below the print heads and adapted to be moved towards the print heads. The printing units can then be cleaned automatically and visually checked at the maintenance position, e.g. when the print heads are being purged.

In one or more examples, the printing units comprise supply units and suction units for ink, which are arranged on the rear side of the printing units that faces away from the carousel. The supply units and suction units are then accessible from outside also at the operating position of the printing unit, e.g. when an associated machine cover has been opened. Thus, it will not be necessary to move the printing units to the maintenance position for the comparatively frequent maintenance of the supply units and suction units.

In at least one embodiment, the printing units comprise proximity sensors and the docking stations comprise position encoders complementary to said proximity sensors, and in particular metallic position encoders, e.g. in the form of metal plates. This allows the function of the chucks to be controlled automatically depending on the determined distance between the printing unit and the receiving area associated therewith.

In one or more embodiments, the printing machine further comprises a machine cover, which is subdivided into pitch circle sections and which, for moving out the printing units, is adapted to be opened selectively in the pitch circle section associated with the printing unit in question. The part of the printing unit facing away from the print heads will then project e.g. beyond a circumferential line defined by the fully closed machine cover. This means that the respective printing units to be serviced are fully accessible, while the other printing units remain protected against detrimental environmental influences.

### BRIEF DESCRIPTION OF THE DRAWINGS

An exemplary embodiment of the present disclosure is shown in the drawings.

FIG. 1 shows a schematic top view of the printing machine.

FIG. 2 shows a printing unit in a schematic side view.

FIG. 3 shows an oblique view of a docking frame formed on the printing units.

FIG. 4 shows an oblique view of receiving areas formed on the carousel, each for receiving a respective docking unit.

FIG. 5 shows an exemplary embodiment of the rail guide.

### DETAILED DESCRIPTION

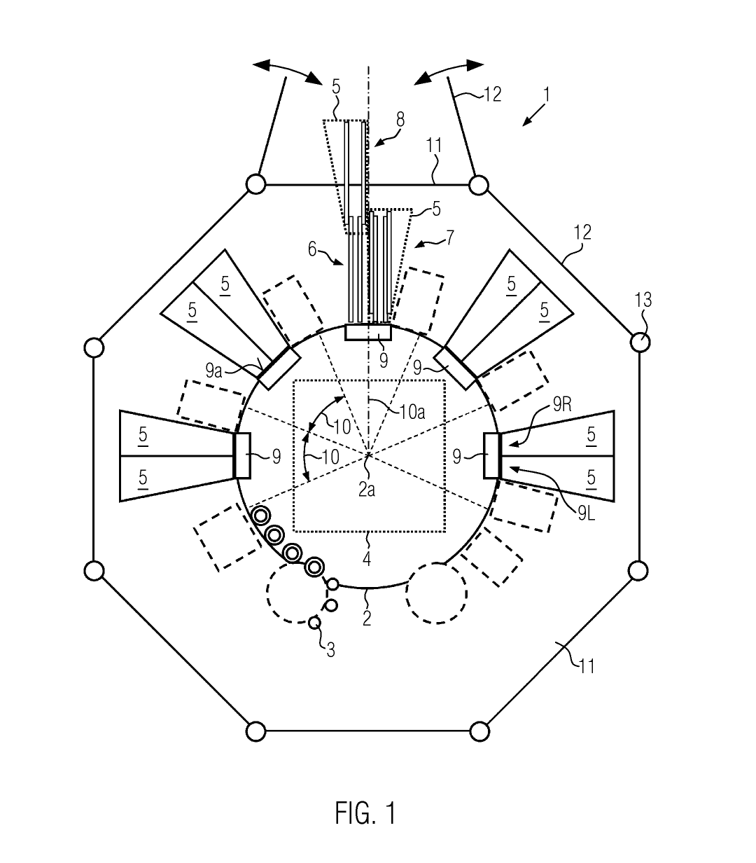

As can be seen in a schematic representation in FIG. 1, the printing machine 1 comprises, in at least one embodiment, a carousel 2 for the continuous conveyance of containers 3 to be printed on. The carousel 2 has evenly distributed thereon holders for the containers 3 on its circumference, said holders being rotatable about their own axis by means of servomotors or the like in the manner known (and only a few of them are shown). The conveyance of the containers 3 on the carousel 2 and the rotation of the containers 3 during direct printing are known in principle and are therefore not explained in detail.

The printing machine 1 also comprises a stationary basic frame 4 for the carousel 2 and a plurality of dockable printing units 5, which are, for example, identical as regards their basic function, but which may e.g. differ with respect to circulating or non-circulating ink supplies depending on the printing ink to be processed.

Additional units, such as, for example, UV curing units for printing ink provided downstream of a respective combination of two printing units 5, inspection units on the input and output sides as well as infeed and delivery star wheels are indicated in dashed lines in FIG. 1 for illustration without a separate designation.

The printing units 5 are each mounted on a rail guide 6, by means of which they can be moved from an inner operating position 7 in a direction away from the carousel 2 to an outer maintenance position 8 and back again. FIG. 1 shows exemplarily a printing unit 5 at its outer maintenance position 8 and all the other printing units 5 at their inner operating position 7.

The rail guides 6 have stationarily associated therewith stationary docking stations 9 for the printing units 5. The docking stations 9 for example comprise (when seen from the printing unit 5) a right-hand receiving area 9R and a left-hand receiving area 9L, each for receiving one printing unit 5. The two receiving areas 9R, 9L have a substantially identical structural design and they may comprise end plates 9a, which are aligned with one another, or a common end plate 9a for docking on the printing units 5.

As can further be seen in FIG. 1, the printing machine 1 is divided into a plurality of identical pitch circle sections 10, with two respective printing units 5 being arranged in a substantially axially symmetrical manner with respect to a common displacement axis 10a of the respective pitch circle section 10. The respective displacement axis 10a is aligned radially with respect to the axis of rotation 2a of the carousel 2. Both rail guides 6 of a certain pitch circle section 10 extend parallel to the displacement axis 10a, in at least one example.

The individual printing units 5 can be moved on their rail guides 6, for example, independently of one another, up to and into the outer maintenance position 8. There, the printing units 5 are accessible for maintenance work. Depending on the maintenance to be performed, only one or both printing stations 5 of a certain pitch circle section 10 can then be moved to the maintenance position 8.

FIG. 1 also shows a mounting plate 11 for the rail guides 6 and a protective cover 12, which laterally delimits the printing machine 1. The mounting plate 11 defines a machine bottom and may, for example, consist of firmly connected area segments.

The rail guides 6 are in at least one example screwed to the mounting plate 11 or attached thereto in some other way for stationarily assigning the rail guides 6 to the docking stations 9. The mounting plate 11 is firmly connected to the basic frame 4 for this purpose.

The protective cover 12 is segmented in one or more examples by means of bearing columns 13, in particular in such a way that it can be opened separately for individual pitch circle sections 10 to allow selective access to the associated printing units 5. This is schematically indicated in FIG. 1 above.

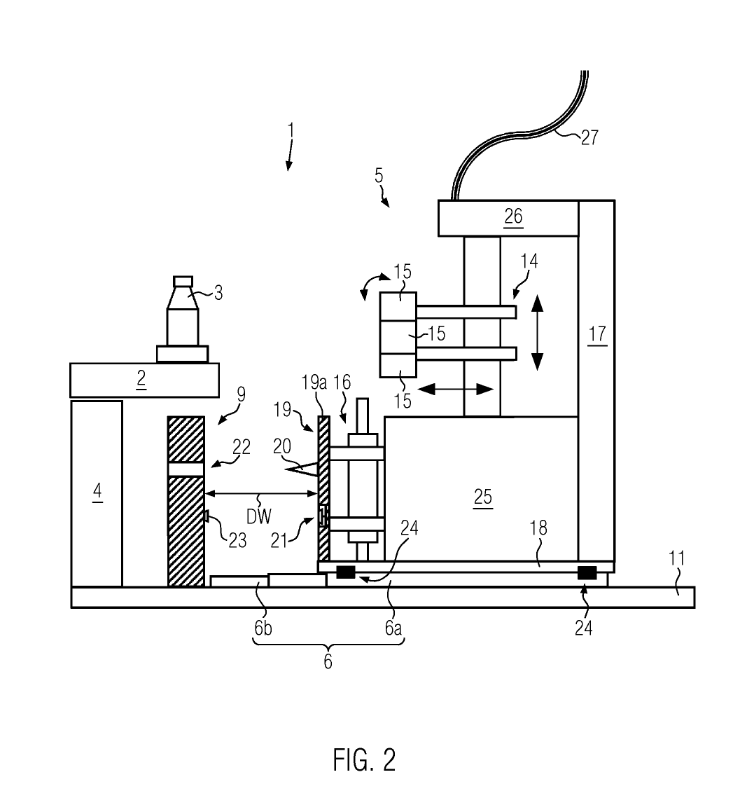

As can be seen from the schematic representation of FIG. 2, the printing units 5 are essentially configured as modules that are each capable of operating individually. For this purpose, the printing units 5 comprise adjustment units 14 with a plurality of print heads 15, which, in at least one example, can be adjusted in a radial direction with respect to the carousel 2 as well as in their height position. In one or more examples, it is also possible to tilt the print heads 15 using the adjustment unit 14. This is indicated by double arrows.

In particular, the adjustment unit 14 is used for the independent positioning/adjustment of the individual print heads 15. The adjustment unit 14 may comprise mutually interchangeable modules, which differ e.g. with respect to the number of print heads 15, with respect to different degrees of freedom of positioning/adjustment and/or associated adjustment paths, with respect to their adaptability to different pitch circle sections and/or with respect to different print head types.

The printing units 5 further comprise cleaning units 16 with cleaning heads that can be moved upwards towards the print heads 15. In at least one example embodiment, the cleaning units 16 comprise a number of cleaning heads corresponding to the number of print heads 15, said cleaning heads being adapted to be raised automatically from a parking position so as to clean the print heads 15.

The printing units 5 also comprise supply units 17 for printing ink/ink. The supply units 17 may be arranged on the rear side of the printing units 5 facing away from the carousel 2 and are therefore in principle accessible to persons also at the operating position 7.

The supply units 17 are used in particular for supplying ink to the print heads 15 as well as for supplying media to an associated printing mist extraction unit (not shown) and to the cleaning units 16, optionally also to a local compressed air supply or the like. The rear arrangement of the supply units 17 on the printing units 5 allows particularly good access to components, assemblies or the like, e.g. for a regular and/or wear-related replacement of ink filters, degassing cartridges of the ink supply or the like. Modular subunits, such as a specific ink supply, can be replaced, if a different type of print head is to be used or if other demands on the ink supply change.

The printing units 5 further comprise basic frames 18 and docking frames 19 fixedly connected thereto, which are used for docking to the docking stations 9. The docking frames 19 comprise end plates 19a with centering bolts 20 and chucks 21, which are complementary to centering holes 22 and clamping bolts 23 formed on the docking stations 9.

The basic frames 18 are mounted on the moving parts 6a of the rail guides 6 in an elastically flexible manner. The stationary parts 6b of the rail guides 6 are fastened to the mounting plate 11, for example by screwing, clamping or the like.

Due to the flexible bearing 24 of the basic frames 18, the docking frames 19 and the docking stations 9 can be driven into contact with one another by means of the centering bolts 20 and centering holes 22 in a self-centering manner and can then be locked together with low tension by means of the chucks 21 and clamping bolts 23. If positioning inaccuracies remain between the docking frames 19 and the docking stations 9 in spite of a height-level adjustment of the printing units 5, these inaccuracies will be compensated for by the flexible bearing 24 of the basic frames 18, and the chucks 21 and the clamping bolts 23 will be relieved thereof.

This allows a very precise and reproducible positioning of the printing units 5 and their print heads 15 with respect to the carousel 2, so that the docking frames 19 with the associated docking stations 9 each form separate zero-point clamping systems.

For the sake of clarity, the printing unit 5 is shown in FIG. 2 at its maintenance position 8, i.e. at a suitable radial distance DW from the carousel 2. The distance DW is defined e.g. between the end plates 9a, 19a of the docking stations 9 and of the docking frames 19. In contrast to the operating position 7, docking frames 19 and docking stations 9 associated with one another do not contact one other at the maintenance position 8.

The printing units 5 further comprise terminal boxes 25 for establishing electrical connections or the like and supply units 26 for the central supply of the printing units 5 with energy, compressed air or the like.

The terminal boxes 25 are, in one or more examples, arranged at a lower central position on the printing units 5 in order to keep the effort and the outlay for internal wiring and wiring to the carousel 2, i.e. to the basic machine, as low as possible.

The supply units 26 may be connected centrally via flexible lines 27 or the like so as not to obstruct the movability of the printing units 5 between the operating position 7 and the maintenance position 8. The flexible lines 27, such as cables, hoses or the like, are guided e.g. in drag chains.

In one or more examples, the number of lines 27 between the printing units 5 and the carousel 2 or the basic machine may be minimized. For example, a power supply and a data connection to the respective printing unit 5 may be sufficient. In addition, connecting lines may be advantageous in particular for those media/functions that can be stored/provided particularly efficiently in the area of the carousel 2 or the basic machine, such as central compressed air generation, vacuum generation, extraction, an ink refill station or the like.

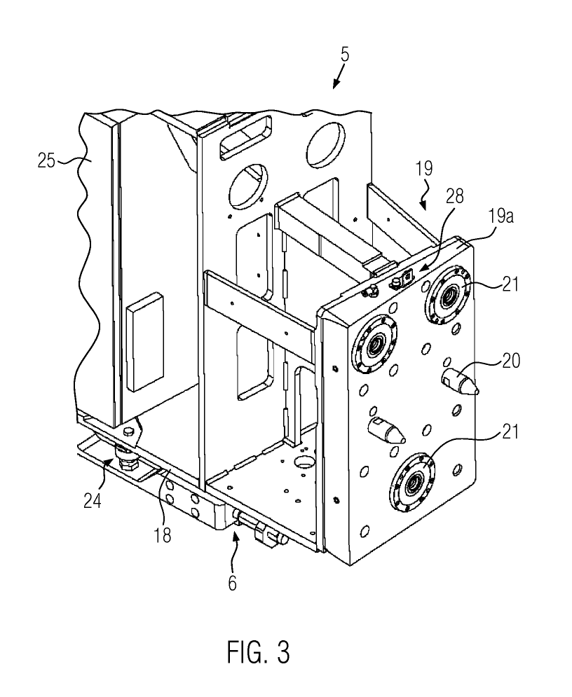

FIG. 3 illustrates embodiments of the centering bolts 20, which are formed on the docking frame 19 for pre-centering and which may taper conically at the free end thereof, and of the chucks 21 used for final positioning and locking of the printing units 5 on the docking stations 9. In at least one example, the docking frame 19 has attached thereto a proximity sensor 28, by means of which the approach of the printing unit 5 to the associated receiving area 9R, 9L can be monitored. In addition, the end plate 19a of the docking frame 19 and the basic frame 18 with its flexible bearing 24 on the rail guide 6 can be seen. For the purpose of orientation, the end plate 19a may be wedge-shaped such that it matches the complementary end plate 9a.

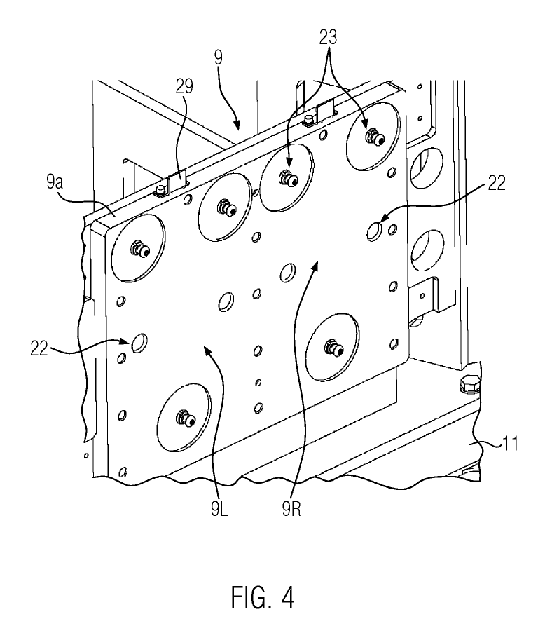

FIG. 4 shows embodiments of the centering holes 22 that are complementary to the centering bolts 20 and of the clamping bolts 23 that are complementary to the chucks 21 for two adjacent receiving areas 9R, 9L. Also indicated are position encoders 29 which are complementary to the proximity sensors 28 and configured e.g. as query plates or the like.

The centering bolts 20 and the associated centering holes 22 may be configured twofold per printing unit 5 and receiving area 9L, 9R. The chucks 21 and the clamping bolts 23 are, in at least one example, configured threefold per printing unit 5 and receiving area 9L, 9R. This allows sufficiently precise precentering on the one hand, and exact positioning and locking of the printing units 5 both in a horizontal and in a vertical direction on the other.

To this end, the docking frames 19 and the receiving areas 9L, 9R comprise end plates 19a and 9a which may be aligned orthogonally to the centering bolts 20 and the clamping bolts 23 and lying flat against each other in the locked condition of the printing units 5. This ensures stable as well as precise guidance and locking of the printing units 5 to/on the docking stations 9. Likewise, it can be seen that the receiving areas 9R, 9L may share a common end plate 9a. However, this is just as little absolutely necessary as an aligned mode of arrangement of the receiving areas 9L, 9R.

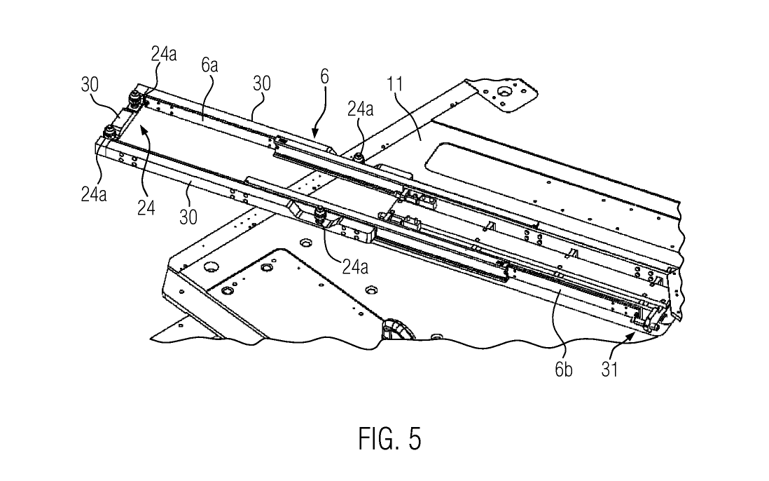

FIG. 5 illustrates the elastically flexible bearing 24 of the basic frames 18 of the printing units 5 on the rail guides 6. For this purpose, e.g. carriers 30 are screwed to the movable parts 6a of the rail guide 6.

The elastic bearing 24, in particular in the form of elastically flexible support elements 24a for the basic frames 18, rests on the carriers 30. This allows an immovable connection between the printing units 5 and the moving parts 6a of the rail guides 6, for example during a displacement to the maintenance position 8. Likewise, a compensatory mobility of the printing units 5 with respect to the rail guides 6 during docking at the operating position 7 is made possible.

Consequently, the chucks 21 and the clamping bolts 23 can interact substantially without any external bracing and lock the printing units 5 on the docking stations 9 in an exact and reproducible manner.

The elastically flexible support elements 24a are configured e.g. as rubber-metal buffers. The rubber-metal buffers are then fastened to the carriers 30, e.g. by means of locked threaded bolts, so that the height level of the printing units 5 on each support element 24a can be adjusted separately with respect to the respective rail guide 6. This allows the height level of the centering bolts 20 to be adjusted to the associated centering holes 22 for the purpose of precentering.

Height-adjustable support elements 24a allow a particularly careful precentering and subsequent positioning of the chucks 21 on the clamping bolts 23. The chucks 21 thus remain protected against damage when approaching the operating position 7 and still allow a reproducible and positionally accurate fastening and locking of the printing units 5 to their respective receiving areas 9R, 9L.

FIG. 5 also shows that the rail guides 6 may be configured as heavy-duty full extension units having e.g. an extension length of at least 750 mm. In the area of the operating position 7 and/or the maintenance position 8, the full extension unit may comprise stop dampers 31 for vibration-free positioning.

The rail guides 6 may, in principle, also be configured such that the printing units 5 can be moved completely out of the area of the printing machine 1 and can be separated from the latter. In this case, the rail guides 6 would not be configured as heavy-duty extension units, but e.g. as open guide rails in/on which the printing units 5 run on wheels. However, the full extension units described are advantageous with regard to the significantly lower adjustment effort for the print heads 15, i.e. with regard to the more easily reproducible positioning at the operating position 7.

Although all rail guides 6 in FIG. 1 have assigned thereto printing units 5, this is not necessary for the functionality of the printing machine 1. Individual or both receiving areas 9R, 9L of certain docking stations 9 may remain free. In principle, the printing units 5 can be docked to the printing machine 1 in any arrangement and sequence. To this end, the basic frames 18 of all printing units 5 may comprise identical mounting points, which match the support elements 24a on the rail guides 6.

Due to the modular design, especially as regards their support/fastening on the rail guides 6, the printing units 5 can there be pre-assembled, put into operation and/or tested independently of the basic machine/carousel 2, e.g. by connecting them to a simulator for simulating the basic machine. Under these conditions, efficient maintenance/overhauling of the printing units 5 is possible as well.

Identical printing units 5 may be used on differently sized pitch circles/basic machines. Printing machines 1 may only partially be equipped with printing units 5. In principle, it is also possible to successively expand the functional scope of printing machine 1 by providing an increasing number of pitch circle sections 10 and/or receiving areas 9R, 9L with printing units 5.

It would also be imaginable to attach, instead of individual printing units 5, other treatment units with essentially identical mounting points to the rail guides 6, such as film wrapping modules (not shown). In addition, printing units 5 or other treatment units may easily be replaced by technologically more refined types.

The printing units 5 are, in at least one example, configured and controlled in such a way that their functions can be tested independently of the carousel 2 or the printing machine 1. For this purpose, the printing units 5 may e.g. be connected to a suitable machine simulator. For putting the tested printing units 5 into operation on the printing machine 1, it will then suffice to establish a central connection making use of the flexible lines 26 and to carry out an initial print head adjustment.

Furthermore, access to individual assemblies and/or components, such as adjustment units 14, print heads 15, terminal boxes 25 or the like, is improved, especially at the maintenance position 8.

1. A printing machine for direct printing on containers, comprising: a continuously rotatable carousel for conveying the containers; a plurality of printing units; and stationary docking stations for docking the printing units to a periphery of the carousel, wherein rail guides stationarily associated with the docking stations are used for moving the printing units from a docked-on operating position outwards to a maintenance position, and back again.

2. The printing machine according to claim 1, wherein the printing units are moved separately.

3. The printing machine according to claim 1, wherein the maintenance position is spaced apart from the carousel.

4. The printing machine according to claim 1, wherein the rail guide is configured such that a distance between docking frames of the printing units and associated docking stations is, at the maintenance position, at least 0.3 m.

5. The printing machine according to claim 4, wherein the distance between the docking frames of the printing units and the associated docking stations is, at the maintenance position, at least 0.6 m.

6. The printing machine according to claim 1, wherein the rail guides comprise heavy-duty full extension units.

7. The printing machine according to claim 6, wherein the heavy-duty full extension units have an extension length of at least 750 mm.

8. The printing machine according to claim 1, further comprising at least one mounting plate extending radially beyond the carousel and connected to a stationary basic frame of the printing machine, the rail guides being fixed to/formed in said mounting plate.

9. The printing machine according to claim 1, wherein the printing machine comprises a plurality of identical pitch circle sections, each having arranged therein a docking station with two receiving areas of a same kind, each docking station for a respective printing unit, and two of the rail guides the two rail guides parallel to one another.

10. The printing machine according to claim 9, wherein the respective receiving areas and the rail guides are arranged on both sides with respect to a common radial displacement axis for the printing units associated therewith.

11. The printing machine according to claim 10, wherein the respective receiving areas and the rail guides are arranged on both sides in an axially symmetrical manner with respect to the common radial displacement axis for the printing units associated therewith.

12. The printing machine according to claim 1, wherein the printing units comprise conically tapering centering bolts for precentering and chucks for locking the printing units at the periphery of the carousel, and the docking stations comprise centering holes and clamping bolts complementary to said centering bolts and chucks.

13. The printing machine according to claim 1, wherein the printing units comprise basic frames with uniform mounting points for the rail guides.

14. The printing machine according to claim 14, further comprising a height-adjustable and/or elastically flexible bearing of the printing units on the rail guides.

15. The printing machine according to claim 1, wherein the printing units each comprise at least one adjustment unit for separately adjusting print heads with respect to vertical and radial positions of the print heads as well as a tilt of the print heads towards the carousel.

16. The printing machine according to claim 15, wherein the printing units comprise cleaning units, with cleaning heads parked below the print heads and adapted to be motor-driven for displacement towards the print heads.

17. The printing machine according to claim 16, wherein the cleaning units are identical cleaning units.

18. The printing machine according to claim 1, wherein the printing units comprise supply units for ink which are arranged on the rear side of the printing units that faces away from the carousel.

19. The printing machine according to claim 1, wherein the printing units comprise proximity sensors and the docking stations comprise position encoders complementary to said proximity sensors, or vice versa.

20. The printing machine according to claim 1, further comprising a machine cover which is subdivided into pitch circle sections and which, for moving out individual printing units, is adapted to be opened selectively in the pitch circle section associated with the printing unit.
